(19) United States
(12) Patent Application Publication
(10) Pub. No.: US 2023/0412646 A1
(43) Pub. Date: Dec. 21, 2023

(54) FLEXIBLE LABELS FOR WORKLOADS IN A NETWORK MANAGED VIRTUALIZED COMPUTING SYSTEM

(71) Applicant: VMware, Inc., Palo Alto, CA (US)

(72) Inventors: Anthony FENZL, Mountain View, CA (US); Vinith PODDUTURI, Fremont, CA (US); Suresh NAGAR, Fremont, CA (US); Bo JIN, Santa Clara, CA (US); Lei LEI, San Francisco, CA (US); Shahram GHARDASHEM, San Jose, CA (US)

(21) Appl. No.: 18/331,038

(22) Filed: Jun. 7, 2023

Related U.S. Application Data
(60) Provisional application No. 63/352,927, filed on Jun. 16, 2022.

(51) Int. Cl. H04L 9/40; H04L 41/14; H04L 41/22

(52) U.S. Cl. CPC H04L 63/20; H04L 41/14; H04L 41/22

(57) ABSTRACT

An example method of analyzing workloads executing in a network managed virtualized computing system includes: presenting, by a network analyzer, a first view of the workloads on a canvas to a first user; receiving, at the network analyzer, first user input to create a first label, the first label initially disassociated with security policies of a network manager managing a software defined network used by the workloads; receiving, at the network analyzer, second user input to assign the first label to at least one of the workloads; and presenting, by the network analyzer, a second view of the workloads on the canvas to the first user having a first group of the at least one workload and a second group having workloads other than the at least one workload.

### CROSS-REFERENCE TO RELATED APPLICATIONS

This application claims priority to U.S. Provisional Patent Application Ser. No. 63/352,927, filed Jun. 16, 2022, which is incorporated by reference in its entirety.

### BACKGROUND

Applications today are deployed onto a combination of virtual machines (VMs), containers, application services, and more within a software-defined datacenter (SDDC). The SDDC includes a server virtualization layer having clusters of physical servers that are virtualized and managed by virtualization management servers. Each host includes a virtualization layer (e.g., a hypervisor) that provides a software abstraction of a physical server (e.g., central processing unit (CPU), random access memory (RAM), storage, network interface card (NIC), etc.) to the VMs. A virtual infrastructure administrator (“VI admin”) interacts with a virtualization management server to create server clusters (“host clusters”), add/remove servers (“hosts”) from host clusters, deploy/move/remove VMs on the hosts, deploy/configure networking and storage virtualized infrastructure, and the like. The virtualization management server sits on top of the server virtualization layer of the SDDC and treats host clusters as pools of compute capacity for use by applications.

Detailed visualization of workloads and traffic flows in a large, distributed network of applications in a way that is consumable by a user is a challenging problem. It is desirable to create large scale visualizations of SDDC network traffic, security policies, and other network events. Such visual representations of network traffic can be used to identify communication patterns, workload usage patterns, and the like for users. It is desirable to provide different techniques to organize and group objects in a logical manner for a user.

### SUMMARY

In an embodiment, a method of analyzing workloads executing in a network managed virtualized computing system includes: presenting, by a network analyzer, a first view of the workloads on a canvas to a first user; receiving, at the network analyzer, first user input to create a first label, the first label initially disassociated with security policies of a network manager managing a software defined network used by the workloads; receiving, at the network analyzer, second user input to assign the first label to at least one of the workloads; and presenting, by the network analyzer, a second view of the workloads on the canvas to the first user having a first group of the at least one workload and a second group having workloads other than the at least one workload.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a virtualized computing system in which embodiments described herein may be implemented.

FIG. 2 is a block diagram depicting a view of a security posture map according to an embodiment.

FIG. 3 is a block diagram depicting another view of a security posture map according to an embodiment.

FIG. 4 is a flow diagram depicting a method of labeling workloads in a network managed virtualized computing system according to embodiments.

### DETAILED DESCRIPTION

Flexible labels for workloads in a network managed virtualized computing system are described. In embodiments, a network analyzer presents views of workloads in a data center on a canvas to a user. The workloads comprise virtual machines (VMs), containers, or any other virtual computing instances. In embodiments, the workloads can be grouped on the canvas based on their network flows. A network flow includes, for example, source Internet Protocol (IP) address, destination IP address, source port, destination port, type of IP service. IP protocol, ingress/egress interfaces, and the like. Workloads with the same or similar network flows can be grouped on the canvas. In embodiments, the user can provide input to the network analyzer to create label(s) and to apply the label(s) to workloads. The labels can be arbitrary and unrelated to network flows. The labels are initially disassociated with security policies being applied in the data center by a network manager. The workloads can then be shown on the canvas grouped according to their labels. In embodiments, the user can promote a label to be associated with a security policy such that the security policy is applied to the labeled workloads. These and further aspects are described below with reference to the drawings.

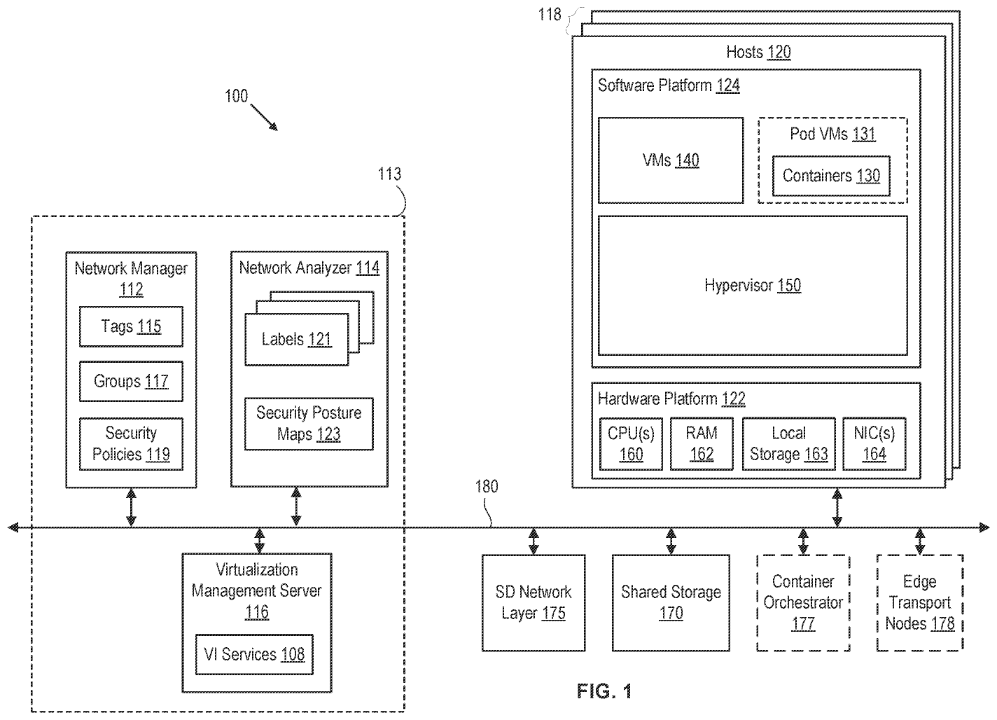

FIG. 1 is a block diagram of a virtualized computing system 100 in which embodiments described herein may be implemented. System 100 includes a cluster of hosts 120 (“host cluster 118”) that may be constructed on server-grade hardware platforms such as an x86 architecture platforms. For purposes of clarity, only one host cluster 118 is shown. However, virtualized computing system 100 can include many of such host clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 180. Physical network 180 enables communication between hosts 120 and between other components and hosts 120 (other components discussed further herein). Physical network 180 can include a plurality of VLANs to provide external network virtualization as described further herein. While one physical network 180 is shown, in embodiments, virtualized computing system 100 can include multiple physical networks that are separate from each other (e.g., a separate physical network for storage).

In the embodiment illustrated in FIG. 1, hosts 120 access shared storage 170 by using NICs 164 to connect to network 180. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks (SSDs), flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN (vSAN), which is another form of shared storage 170. Virtualization management server 116 can select which local storage devices in hosts 120 are part of a vSAN for host cluster 118.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, CA.

In embodiments, host cluster 118 is configured with a software-defined (SD) network layer 175. SD network layer 175 includes logical network services executing on virtualized infrastructure in host cluster 118. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches, logical routers, logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to an external network (e.g., a corporate network, the public Internet, etc.). Edge transport nodes 178 can include a gateway between the internal logical networking of host cluster 118 and the external network. Edge transport nodes 178 can be physical servers or VMs.

In embodiments, virtualization management server 116 is a physical or virtual server that manages host cluster 118 and the virtualization layer therein. Virtualization management server 116 can be deployed as VM(s) 140, containers (e.g., pod VM(s) 131 discussed below), or a combination thereof. Virtualization management server 116 installs agent(s) in hypervisor 150 to add a host 120 as a managed entity. Virtualization management server 116 logically groups hosts 120 into host cluster 118 to provide cluster-level functions to hosts 120, such as VM migration between hosts 120 (e.g., for load balancing), distributed power management, dynamic VM placement according to affinity and anti-affinity rules, and high-availability. The number of hosts 120 in host cluster 118 may be one or many. Virtualization management server 116 can manage more than one host cluster 118.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs, containers, or a combination thereof. Network manager 112 installs additional agents in hypervisor 150 to add a host 120 as a managed entity, referred to as a transport node. In this manner, host cluster 118 can be a cluster of transport nodes. One example of an SD networking platform that can be configured and used in embodiments described herein as network manager 112 and SD network layer 175 is a VMware NSX® platform made commercially available by VMware, Inc. of Palo Alto, CA.

Virtualization management server 116 and network manager 112 comprise a virtual infrastructure (VI) control plane 113 of virtualized computing system 100. Virtualization management server 116 can include VI services 108. VI services 108 include various virtualization management services, such as a distributed resource scheduler (DRS), high-availability (HA) service, single sign-on (SSO) service, virtualization management daemon, vSAN service, and the like. A VI admin can interact with virtualization management server 116 through a VM management client. Through a VM management client, a VI admin commands virtualization management server 116 to form host cluster 118, configure resource pools, resource allocation policies, and other cluster-level functions, configure storage and networking, and the like.

In embodiments, workloads can also execute in containers 129. In embodiments, hypervisor 150 can support containers 129 executing directly thereon. In other embodiments, containers 129 are deployed in VMs 140 or in specialized VMs referred to as “pod VMs 131.” A pod VM 131 is a VM that includes a kernel and container engine that supports execution of containers, as well as an agent (referred to as a pod VM agent) that cooperates with a controller executing in hypervisor 150. In embodiments, virtualized computing system 100 can include a container orchestrator 177. Container orchestrator 177 implements an orchestration control plane, such as Kubernetes®, to deploy and manage applications or services thereof in pods on hosts 120 using containers 129. Container orchestrator 177 can include one or more master servers configured to command and configure controllers in hypervisors 150. Master server(s) can be physical computers attached to network 180 or implemented by VMs 140/131 in a host cluster 118.

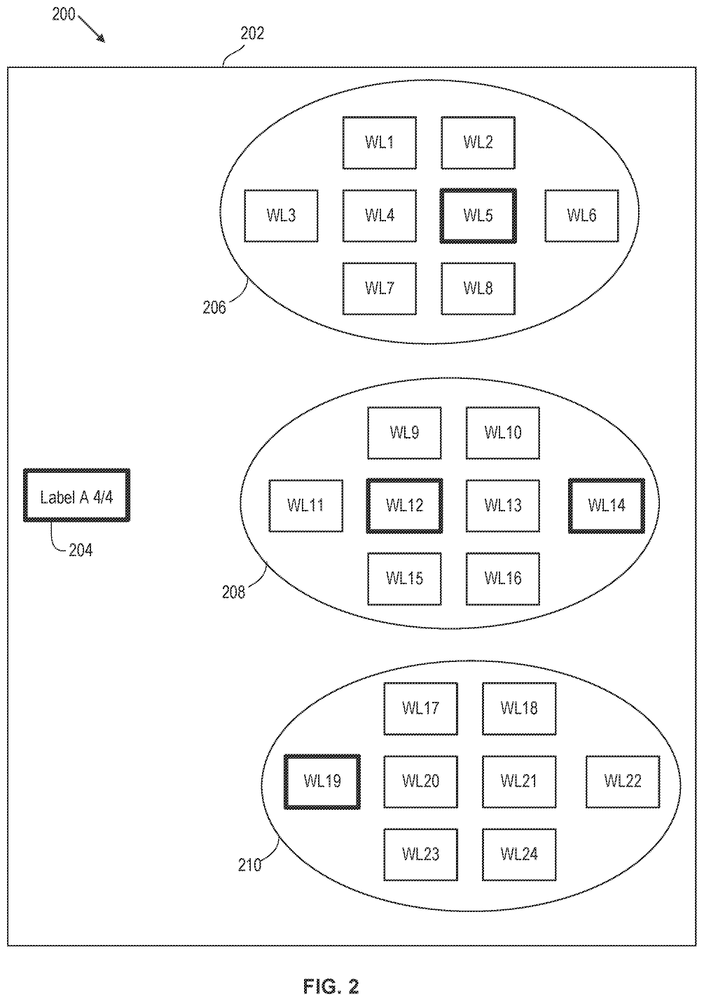

In embodiments, virtualized computing system 100 includes a network analyzer 114. Alternatively, network analyzer 114 can be located in another SDDC of a multi-cloud system or otherwise be located external to virtualized computing system 100. Users interact with network analyzer 114 to visualize network traffic. Network analyzer 114 performs automated clustering of similar workloads (e.g., VMs 131/140) on a canvas displayed to a user. In embodiments, network analyzer 114 can group together workloads on the canvas that share similar network traffic, referred to as flow similarity. In such case, network analyzer 114 creates a security posture map 123 that is easier to read by the users, while also giving insights as to which workloads might perform similar or related functions. An example security posture map 123 is described below with respect to FIG. 2.

There are situations, however, where a user may want to group workloads together by some arbitrary criteria, e.g., which workloads have been updated with a certain patch, which logical function the workloads perform, singling out a specific set of network flows, etc. One approach is to use tags 115 and/or groups 117 exposed by network manager 112. A user can interact with network manager 112 to add workloads to different groups 117. Different security policies 119 can then be applied to different groups 117 of workloads. A user can interact with network manager 112 to add tags 115 to workloads. Workloads having different tags 112 can be dynamically added/removed from groups 117 based on such tags 115. There are some issues with using tags 115 and groups 117 for grouping workloads based on user-defined arbitrary criteria. First, users of network analyzer 114 and users of network manager 112 may be from different user groups having different knowledge. For example, users who access network manager may not haven intimate visibility into applications on the network, while users who access network analyzer 114 may not have knowledge of the various security policies 119 and network configurations achieved using tags 115 and groups 117. In addition, making changes to groups 117 and/or tags 115 can have unintended consequences, such as changing how firewall rules behave or breaking or altering the behavior of existing automation. Further, creating tags 115 and/or groups 117 can be cumbersome for users of network analyzer 114. Since these concepts are not native to network analyzer 114, a user must switch between multiple screens and enter data into a grid in order to get the desired result. It is not practical for the user to use groups 117 and/or tags 115 for the quick visualization needed in debugging or investigation scenarios. Finally, tags 115 and groups 117 are globally applied to workloads across all users of network manager 112. An individual user cannot make tags 115 or groups 117 that are only visible to that user.

While flow clustering often provides a good start for visualizing complex network traffic, users often have the desire to group workloads in their own way to fit their specific needs. Users should be able to cluster workloads on the canvas as they wish, to accommodate unique scenarios, without having to worry about down the line repercussions (e.g., as would be present if using tags 115 and/or groups 117). Thus, in embodiments, network analyzer 114 allows users to assign labels 121 to workloads. Labels 121 are unique to each user and hence network analyzer 114 maintains sets of labels 121 for the various users. A label 121 is a concept unique to network analyzer 114 and detached from network manager 112. This means that a user can create, modify, or delete a label 121 without fear of any repercussions on network manager 112. A user can create a set of labels 112 that makes sense to that user, for their own visualization, without worrying about impacting down the line network policy. Different users can have different sets of labels 121. For example, users of different personas can use network analyzer 114, such as security researchers, network administrators, IT personnel, and the like, each utilizing different sets of labels that organize workloads in a fashion desirable to their persona. User-unique labeling is not possible using tags 115 and/or groups 117, which are global. Tags 115 and groups 117 exist for the system as a whole and there is no concept of showing different sets of tags 115 or groups 117 to specific users.

In embodiments, network analyzer 114 uses industry standard patterns to create, update, and delete labels, such as drag and drop, drag to select, shift click to edit, and the like. A user can zoom in and out of a security posture map 123, which will dynamically provide more or less metadata as the user changes the level of zoom. This allows users to quickly prototype with different kinds of labels 121 and fine tune their assignments over time. In embodiments, labels 121 can be renamed at any time. In embodiments, as the user adds or changes labels, a security posture map 123 changes, including changes to network flows and security alerts, which are recalculated on the fly to demonstrate changes in membership of workloads between labels. When viewing a security posture map 123, labeled workloads are visualized on the canvas grouped together in a labeled grouping with headings matching the label name. When zoomed out, a label group's network flows can be collated for easier viewing in high traffic deployments. Relevant security information can be overlayed on top of security posture map 123 when it becomes available (e.g., security alerts). This type of visualization makes it easy for the user to visualize network and security patterns related to the labeled groups of workloads. To reveal additional information about the network traffic, the user can filter the canvas on network flows coming direct to or from workloads with a specific label. These different views can be shared between users, allowing for communication of insights between different stakeholders.

In embodiments, network analyzer 114 allows a user to promote a label to become a group 117 or a tag 115 through interaction with network manager 112. Groups 117 and/or tags 115 can be used to define firewall rules or other related security policies. A user of network analyzer 114 can apply their labels to these security polices by promoting the labels to groups 117 and/or tags 115. In embodiments, network analyzer 114 also allows a user to export a set of labels 121, as well as import a set of labels 121, from a file (e.g., a comma separate value file).

FIG. 2 is a block diagram depicting a view 300 of a security posture map according to an embodiment. In the embodiment, a canvas 202 displayed to a user of security posture map 200 includes groups 206, 208, and 210 of workloads identified as WL1 through WL24. By default, the workloads can be grouped according to similar network flows. Workloads WL1-WL8 are in group 206, workloads WL9-WL16 are in group 208, and workloads WL17-WL24 are in group 210. A user can interact with canvas 202 using any of the industry standard patterns discussed above to apply a label (“Label A”) to selected ones of the workloads (e.g., WL5, WL12, WL14, and WL19). The labeled workloads can be grouped arbitrarily by the user based on whatever the user selects (e.g., workloads updated with a certain patch).

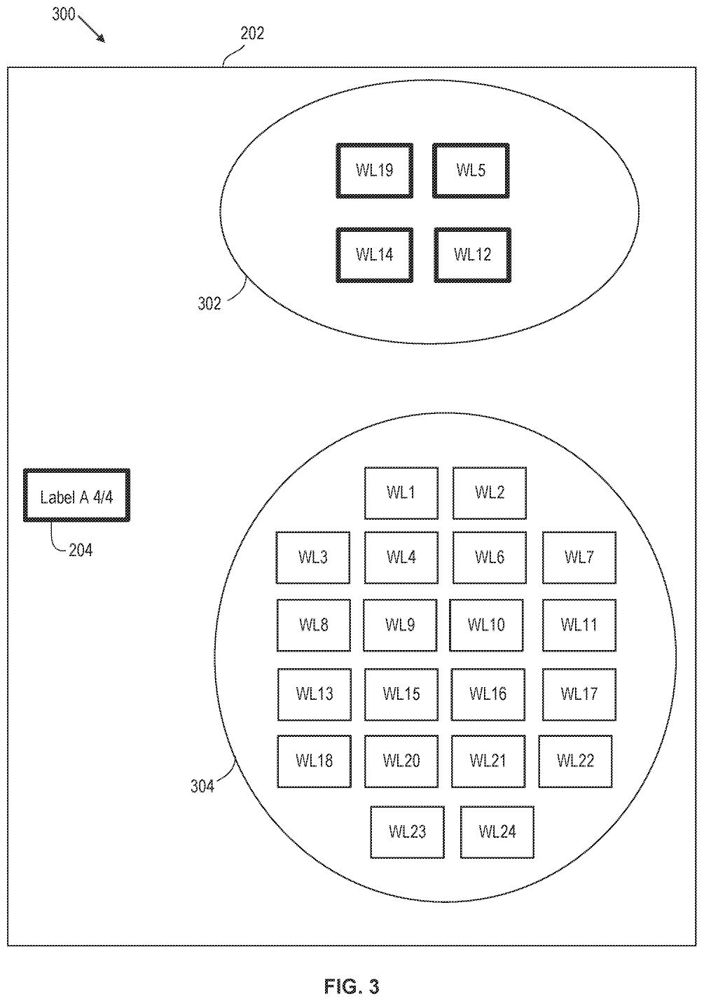

FIG. 3 is a block diagram depicting another view 300 of a security posture map according to an embodiment. In view 300, canvas 202 shows two groups 302 and 304 of the workloads. Group 302 includes the workloads having “Label A” applied thereto, and group 304 includes workloads not having the label (e.g., unlabeled workloads). The user can then view various information associated with the labeled group, such as their network flows, security alerts, and the like.

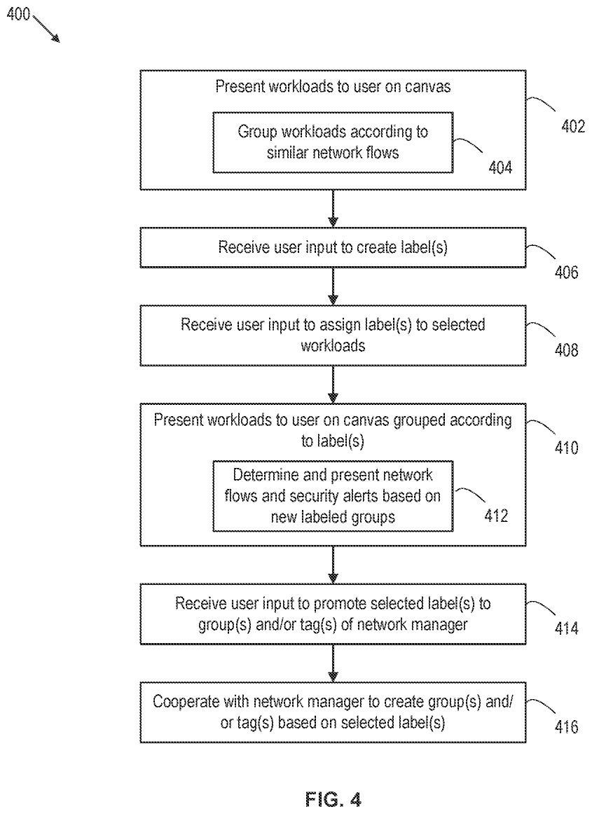

FIG. 4 is a flow diagram depicting a method 400 of labeling workloads in a network managed virtualized computing system according to embodiments. Method 400 begins at step 402, where network analyzer 114 presents a view of the workloads in an SDDC to a user on a canvas. Depending on the number of workloads in the SDDC, network analyzer 114 can present the workloads at various zoom levels based on user input. In embodiments, at step 404, network analyzer 114 by default groups the workloads according to similar network flows. That is, those groups have the same or similar network flows are placed in a group. In this manner, one or more groups are displayed on the canvas to the user.

At step 406, network analyzer 114 receives user input to create one or more labels. The labels can be arbitrary and are associated with the particular user. As discussed above, different users can create different sets of labels. At step 408, network analyzer 114 receives user input to assign the label(s) to selected workloads. At step 410, network analyzer 114 presents the workloads to the user on the canvas grouped according to the label(s). At step 412, network analyzer 114 determines and presents network flows and security alerts based on the newly labeled groups.

At step 414, network analyzer 114 receives user input to promote selected label(s) to group(s) and/or tag(s) of network manager 112. At step 416, network analyzer 114 cooperates with network manager 112 to create group(s) 117 and/or tag(s) 115 based on the selected labels applied to the workloads. For example, network manager 114 can create a tag for each label and apply the tag to the labeled workloads. The tagged workloads can then be dynamically formed into a group 117 to which one or more security policies are applied by network manager 112.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of analyzing workloads executing in a network managed virtualized computing system, the method comprising:
presenting, by a network analyzer, a first view of the workloads on a canvas to a first user;
receiving, at the network analyzer, first user input to create a first label, the first label initially disassociated with security policies of a network manager managing a software defined network used by the workloads;
receiving, at the network analyzer, second user input to assign the first label to at least one of the workloads; and
presenting, by the network analyzer, a second view of the workloads on the canvas to the first user having a first group of the at least one workload and a second group having workloads other than the at least one workload.

2. The method of claim 1, wherein, in the first view, the workloads are grouped according to similar network flows.

3. The method of claim 1, wherein the network manager assigns at least one of tags and groups to the workloads globally, and wherein the first label is independent of the tags and the groups.

4. The method of claim 1, further comprising:
receiving, at the network analyzer, third user input to create a second label from a second user, the second label associated only with the second user and the first label associated only with the first user.

5. The method of claim 1, further comprising:
presenting at least one of network flows and security alerts on the second view based on the first group.

6. The method of claim 1, further comprising:
receiving, at the network analyzer, third user input to promote the first label to a tag managed by the network manager;
creating, by the network analyzer in cooperation with the network manager, the tag based on the first label;
dynamically creating, by the network manager, a group of the workloads based on the tag; and
applying, by the network manager, a security policy to the group.

7. The method of claim 1, further comprising:
receiving, at the network manager, third user input to promote the first label to a group managed by the network manager;
creating, by the network analyzer in cooperation with the network manager, the group based on the first label; and
applying, by the network manager, a security policy to the group.

8. A non-transitory computer readable medium comprising instructions to be executed in a computing device to cause the computing device to carry out a method of analyzing workloads executing in a network managed virtualized computing system, the method comprising:
presenting, by a network analyzer, a first view of the workloads on a canvas to a first user;
receiving, at the network analyzer, first user input to create a first label, the first label initially disassociated with security policies of a network manager managing a software defined network used by the workloads;
receiving, at the network analyzer, second user input to assign the first label to at least one of the workloads; and
presenting, by the network analyzer, a second view of the workloads on the canvas to the first user having a first group of the at least one workload and a second group having workloads other than the at least one workload.

9. The non-transitory computer readable medium of claim 8, wherein, in the first view, the workloads are grouped according to similar network flows.

10. The non-transitory computer readable medium of claim 8, wherein the network manager assigns at least one of tags and groups to the workloads globally, and wherein the first label is independent of the tags and the groups.

11. The non-transitory computer readable medium of claim 8, further comprising:
receiving, at the network analyzer, third user input to create a second label from a second user, the second label associated only with the second user and the first label associated only with the first user.

12. The non-transitory computer readable medium of claim 8, further comprising:
presenting at least one of network flows and security alerts on the second view based on the first group.

13. The non-transitory computer readable medium of claim 8, further comprising:
receiving, at the network analyzer, third user input to promote the first label to a tag managed by the network manager;
creating, by the network analyzer in cooperation with the network manager, the tag based on the first label;
dynamically creating, by the network manager, a group of the workloads based on the tag; and
applying, by the network manager, a security policy to the group.

14. The non-transitory computer readable medium of claim 8, further comprising:
receiving, at the network manager, third user input to promote the first label to a group managed by the network manager;
creating, by the network analyzer in cooperation with the network manager, the group based on the first label; and
applying, by the network manager, a security policy to the group.

15. A virtualized computing system, comprising:
a cluster of hosts executing workloads, the workloads comprising virtual machines (VMs) managed by hypervisors of the hosts;
a network manager configured to manage a software defined network for the workloads; and
a network analyzer configured to:
present a first view of the workloads on a canvas to a first user;
receive first user input to create a first label, the first label initially disassociated with security policies of the network manager;
receive second user input to assign the first label to at least one of the workloads; and
present a second view of the workloads on the canvas to the first user having a first group of the at least one workload and a second group having workloads other than the at least one workload.

16. The virtualized computing system of claim 15, wherein, in the first view, the workloads are grouped according to similar network flows.

17. The virtualized computing system of claim 15, wherein the network manager assigns at least one of tags and groups to the workloads globally, and wherein the first label is independent of the tags and the groups.

18. The virtualized computing system of claim 15, wherein the network analyzer is configured to:
receive third user input to create a second label from a second user, the second label associated only with the second user and the first label associated only with the first user.

19. The virtualized computing system of claim 15, wherein the network analyzer is configured to:
receive third user input to promote the first label to a tag managed by the network manager; and
create, in cooperation with the network manager, the tag based on the first label.

20. The virtualized computing system of claim 15, wherein the network analyzer is configured to:
receive third user input to promote the first label to a group managed by the network manager; and
create, in cooperation with the network manager, the group based on the first label.
